(19) United States
(12) Patent Application Publication
(10) Pub. No.: US 2009/0135152 A1
(43) Pub. Date: May 28, 2009

(54) Gesture detection on a touchpad

(76) Inventor: Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,182

(22) Filed: Sep. 30, 2008

(30) Foreign Application Priority Data
Nov. 23, 2007 (TW) 096144469

(51) Int. Cl. G06F 3/041

(52) U.S. Cl. 345/173

(57) ABSTRACT

A gesture detection on a touchpad includes detecting whether any object touches on the touchpad, and if any object is detected on the touchpad, further detecting whether more object touches on the touchpad, by which it may determine a gesture function to start a default function, such as drag an object, scroll a scrollbar, open a file, or zoom in a picture.

### FIELD OF THE INVENTION

The present invention is related generally to a touchpad and, more particularly, to a gesture detection on a touchpad.

### BACKGROUND OF THE INVENTION

Touchpad has been widely used in various electronic products, for example, notebook computer, personal digital assistant (PDA), mobile phone, and other electronic systems. Touchpad serves as an input device where users touch or slide on the panel of the touchpad by finger or conductive object such as touch pen, to control a cursor on a window in relative movement or absolute coordinate movement and to support other extended functions such as simulated buttons.

In addition to functions of movement, click and double click, one of the most usual input commands by touchpads is drag function. FIG. 1 is a diagram to show a conventional drag gesture detection on a touchpad, in which waveform 10 represents the detected capacitance variation caused by a movement of a finger on the touchpad, and waveform 12 represents the output signal of the touchpad. This detection method starts a drag gesture by clicking once and half. However, it is not easy for some users to click once and half. For example, they may click twice when want to click once and half. Furthermore, this method has some restrictions; for example, it determines the drag function according to a time period t1 which is from the first time a finger touches the touchpad to the first time the finger leaves from the touchpad, a time period t2 which is from the first time the finger leaves to the second time the finger touches the touchpad, and a time period t3 the finger stays on the touchpad after the second touch, but users may not well control these time periods t1, t2 and t3, and thus cause undesired operations.

Therefore, a better method for gesture detection on a touchpad is desired.

### SUMMARY OF THE INVENTION

An object of the present invention is to provide a detection method for a gesture detection on a touchpad.

According to the present invention, a gesture detection on a touchpad includes detecting whether the number of objects touched on the touchpad reaches a first value, then detecting whether the number of the objects on the touchpad reaches a second value, and starting a gesture function if the number of the objects on the touchpad reaches the second value.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a diagram to show a conventional detection method for a drag gesture on a touchpad;

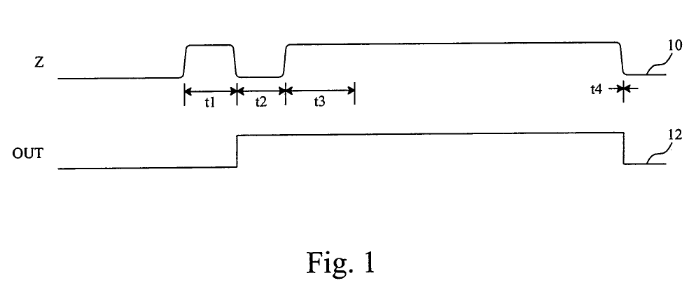

FIG. 2 is a flowchart in a first embodiment according to the present invention;

FIG. 3 is a flowchart in a second embodiment according to the present invention;

FIG. 4 is a flowchart in a third embodiment according to the present invention;

FIG. 5 shows the panel of a touchpad with a defined edge region;

FIG. 6 is a flowchart in a fourth embodiment according to the present invention;

FIG. 7 is a flowchart in a fifth embodiment according to the present invention;

FIG. 8 is a flowchart in a sixth embodiment according to the present invention; and

FIG. 9 is a flowchart in a seventh embodiment according to the present invention.

### DETAILED DESCRIPTION OF THE INVENTION

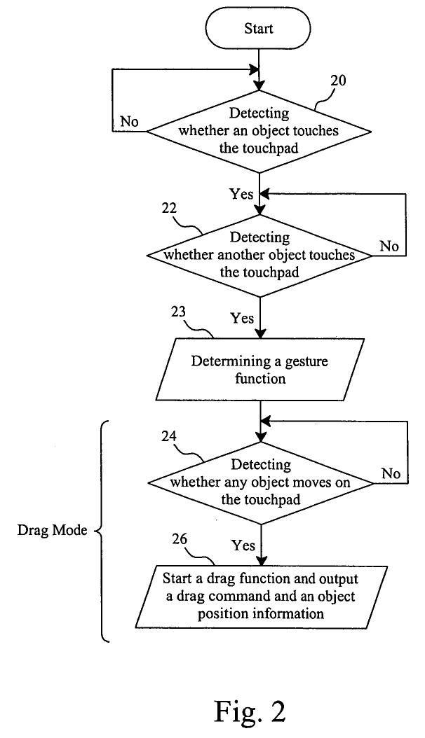

FIG. 2 is a flowchart in a first embodiment according to the present invention. After a touchpad is started, the controller in the touchpad will execute a step 20 to detect whether an object touches the touchpad, and if an object is detected, the controller will execute a step 22 to detect whether another object further touches the touchpad. In the step 22, if two objects are detected on the touchpad at a same time, no matter the second object leaves from the touchpad or stays on the touchpad after touching the touchpad, the controller will execute a step 23 to determine a gesture function, and then enters a drag mode to execute a step 24 to further detect whether any object moves on the touchpad. If any object is detected to move on the touchpad, a step 26 is executed to start a drag function and output a drag command and an object position information to a host.

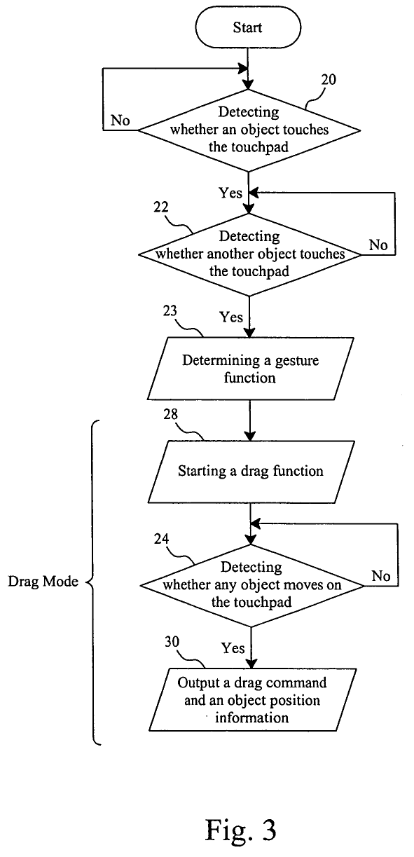

FIG. 3 is a flowchart in a second embodiment according to the present invention. After a touchpad is started, the controller in the touchpad will execute a step 20 to detect whether an object touches the touchpad, and if an object is detected, the controller will execute a step 22 to detect whether another object further touches the touchpad. If two objects are detected on the touchpad at a same time, the controller will execute a step 23 to determine a gesture function, and then enters a drag mode to execute a step 28 to start a drag function. In the drag mode, a step 24 is further executed to detect whether any object moves on the touchpad, and if any object is detected to move on the touchpad, a step 30 is executed to output a drag command and an object position information to a host.

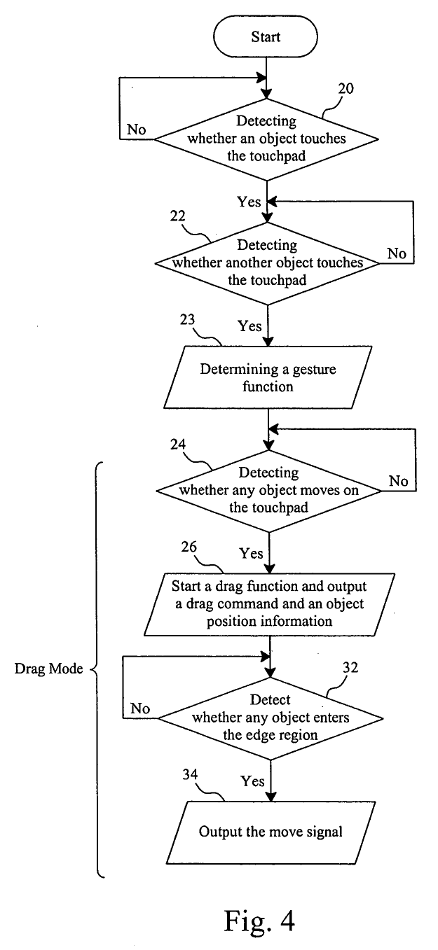

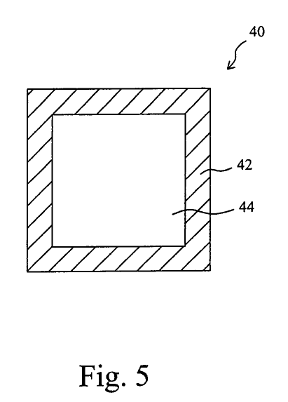

FIG. 4 is a flowchart in a third embodiment according to the present invention. After a touchpad is started, the controller in the touchpad will execute a step 20 to detect whether an object touches the touchpad, and if an object is detected, the controller will execute a step 22 to detect whether another object further touches the touchpad. If two objects are detected on the touchpad at a same time, the controller will execute a step 23 to determine a gesture function, and then enters a drag mode to execute a step 24 to further detect whether any object moves on the touchpad. If any object is detected to move on the touchpad, a step 26 is executed to start a drag function and output a drag command and an object position information to a host. Because a touchpad has a limited size, it is usually defined with an edge region around its edge on the panel to avoid dividing a long distance drag operation into several short distance drag operations. FIG. 5 is a diagram to show a touchpad 40 having a defined edge region 42 indicated by oblique lines. When an object moves from a cursor operation region 44 into the edge region 42, the touchpad 40 will outputs a move signal to a host and thereafter, it will keep the move signal active while there is any object staying within the edge region 42, to keep dragging the dragged object in the original drag direction. In FIG. 4, after the step 26, a step 32 is executed to detect whether any object enters the edge region, and if any object is detected to slide into the edge region, a step 34 is executed to output a move signal to the host as does in an edge function.

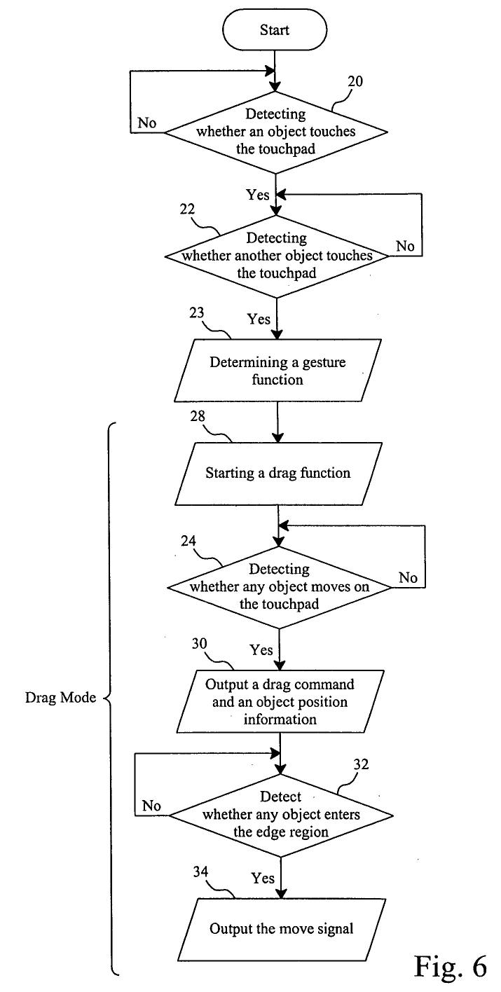

FIG. 6 is a flowchart in a fourth embodiment according to the present invention. After a touchpad is started, the controller in the touchpad will execute a step 20 to detect whether an object touches the touchpad, and if an object is detected, the controller will execute a step 22 to detect whether another object further touches the touchpad. If two objects are detected on the touchpad at a same time, the controller will execute a step 23 to determine a gesture function, and then enters a drag mode to execute a step 28 to start a drag function. In the drag mode, a step 24 is further executed to detect whether any object moves on the touchpad, and if any object is detected to move on the touchpad, a step 30 is executed to output a drag command and an object position information to a host. Then a step 32 is executed to detect whether any object enters an edge region, and if any object is detected to slide into the edge region, a step 34 is executed to output a move signal to the host, to keep dragging the dragged object in the original drag direction.

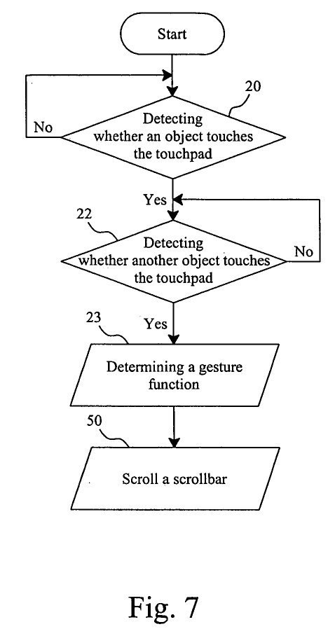

The gesture detection according to present invention can be widely applied, depending on which function the host has defined for this detected gesture. For example, as shown in FIG. 7, after a touchpad is started, the controller in the touchpad executes a step 20 to detect whether an object touches the touchpad, and if an object is detected, the controller executes a step 22 to detect whether another object further touches the touchpad. If two objects are detected on the touchpad at a same time, the controller executes a step 23 to determine a gesture function. In this embodiment, the function defined by a host for this gesture is a scroll function, which includes a step 50 following the step 23 to scroll a scrollbar on a window.

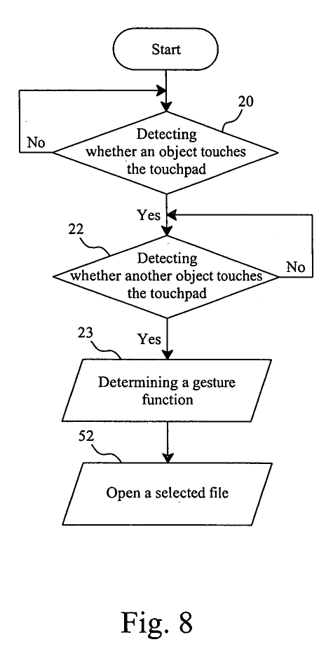

FIG. 8 is a flowchart in a sixth embodiment according to the present invention. After a touchpad is started, the controller in the touchpad will execute a step 20 to detect whether an object touches the touchpad, and if an object is detected, the controller executes a step 22 to detect whether another object further touches the touchpad. If two objects are detected on the touchpad at a same time, the controller executes a step 23 to determine a gesture function which is to open a file on the host, so a step 52 following the step 23 is executed to open a default file, for example a selected file on a window.

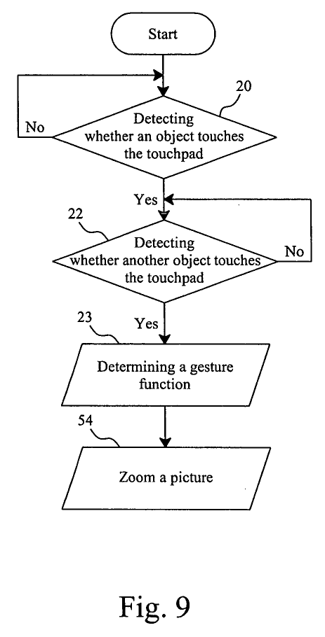

In a further application, as shown in FIG. 9, after a touchpad is started, the controller in the touchpad executes a step 20 to detect whether an object touches the touchpad, and if an object is detected, the controller executes a step 22 to detect whether another object further touches the touchpad. If two objects are detected on the touchpad at a same time, the controller executes a step 23 to determine a gesture function which is to zoom in a picture, so a step 54 following the step 23 is executed to zoom a picture displayed on a window.

In the above embodiments illustrated by FIGS. 2-4 and 6-9, the corresponding gesture function is always determined only when the second object is detected after the first object is detected. However, in other embodiments, the numbers of the objects on a touchpad to determine a gesture function can be designed with different values in these two detection stages. For example, to determine a gesture function, it is to detect whether an object is on the touchpad and then whether another two objects are on the touchpad, or whether two objects are on the touchpad and then whether a third objects is on the touchpad.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A gesture detection on a touchpad, comprising the steps of:
detecting a number of objects on the touchpad;
if the number reaches a first value, further detecting whether the number increases to a second value; and
determining a gesture function if the number reaches the second value.

2. The gesture detection of claim 1, further comprising entering a drag mode after the step of determining a gesture function.

3. The gesture detection of claim 2, wherein the step of entering a drag mode comprises the steps of:
detecting whether any object moves on the touchpad; and
if any object is detected to move on the touchpad, starting a drag function and outputting a drag command and an object position information to a host.

4. The gesture detection of claim 2, wherein the step of entering a drag mode comprises the steps of:
starting a drag function;
detecting whether any object moves on the touchpad after starting the drag function; and
if any object is detected to move on the touchpad, outputting a drag command and an object position information to a host.

5. The gesture detection of claim 1, further comprising scrolling a scrollbar after the step of determining a gesture function.

6. The gesture detection of claim 1, further comprising opening a file after the step of determining a gesture function.

7. The gesture detection of claim 1, further comprising zooming a picture after the step of determining a gesture function.

8. A gesture detection on a touchpad having two regions defined therewith, comprising the steps of:
detecting a number of objects on the first region;
if the number reaches a first value, further detecting whether the number increases to a second value; and
determining a gesture function if the number reaches the second value.

9. The gesture detection of claim 8, further comprising entering a drag mode after the step of determining a gesture function.

10. The gesture detection of claim 9, wherein the step of entering a drag mode comprises the steps of:
detecting whether any object moves on the first region; and
if any object is detected to move on the touchpad, starting a drag function and outputting a drag command and an object position information to a host.

11. The gesture detection of claim 10, further comprising outputting a move signal if the object that has been detected to move on the first region slides into the second region, to keep dragging a dragged object in the original direction that the dragged object is dragged.

12. The gesture detection of claim 9, wherein the step of entering a drag mode comprises the steps of:
starting a drag function;
detecting whether any object moves on the first region after starting the drag function; and
if any object is detected to move on the first region, outputting a drag command and an object position information to a host.

13. The gesture detection of claim 12, further comprising outputting a move signal if the object that has been detected to move on the first region slides into the second region, to keep dragging a dragged object in the original direction that the dragged object is dragged.
